(19) United States
(12) Patent Application Publication
(10) Pub. No.: US 2010/0001918 A1
(43) Pub. Date: Jan. 7, 2010

(54) PASSIVE REPEATER ANTENNA

(75) Inventors: Bengt Svensson, Molndal (SE); Anders Stjernman, Lindome (SE)

Correspondence Address: ERICSSON INC., 6300 LEGACY DRIVE, M/S EVR 1-C-11, PLANO, TX, 75024, US

(73) Assignee: TELEFONAKTIEBOLAGET LM ERICSSON (PUBL), Stockholm (SE)

(21) Appl. No.: 11/994,598

(22) PCT Filed: Jul. 4, 2005
(86) PCT No.: PCT/SE2005/001077

§ 371 Date: Jan. 3, 2008

(51) Int. Cl. H01Q 1/38; H01Q 1/48

(52) U.S. Cl. 343/848; 343/700 MS

(57) ABSTRACT

The present invention discloses a repeater antenna comprising a plurality of radiation elements arranged in a first electrically conducting layer or plane. The repeater antenna also comprises a ground plane spaced apart from the radiation elements by a layer of dielectric material, and the radiation elements are each given such an extension (L₁, L₂, L₃) and such a distance (D₁₂, D₂₃) to neighboring radiation elements that an incident electromagnetic wave will reflect from the repeater antenna at an angle (α₂) that by a predetermined amount will be greater or smaller than the incident angle (α₂) of the electromagnetic wave. The repeater antenna is plane, and can be either curved or flat.

### TECHNICAL FIELD

The present invention discloses a passive repeater antenna with a plurality of radiation elements arranged in a first layer or plane, and also comprises a ground plane spaced apart from the radiation elements by a dielectric material.

### BACKGROUND ART

Operators of wireless systems such as, for example, cellular telephony systems, often wish to increase the capacity of the system in certain areas. In the case of cellular telephony, the operator may wish to increase the system's capacity within certain areas of a cell.

An increase in the system's capacity in a certain area in a cell can be obtained by installing an additional base station to cover that area. Such an additional base station will usually be a so called “micro” or “pico” base station, i.e. a base station with a reduced capacity compared to an ordinary base station, intended to be used to enhance the capacity of an ordinary base station. Naturally, the same effect can also be achieved using an ordinary base station.

The easiest way of connecting such an additional base station to the next higher level in the system, usually the “ordinary” base station of the cell, is usually to use a radio link connection of the “point to point” kind. This means installing one radio link each at the additional base station and the next higher level in the system. In order to make the connection work, Line Of Sight (LOS) is needed between the two radio links. However, operators who wish to make such installations often find that the site at which the additional base station should be installed is not within line of sight (LOS) to higher levels in the system.

One solution to the problem of having two radio links which need LOS but don't have LOS is to install repeater antennas to connect the two radio links to each other. Repeater antennas on the frequency ranges used for cellular telephony, i.e. the microwave range, are usually designed using two parabolic reflectors connected by a waveguide, with the reflectors pointing in different directions.

A repeater antenna which consists of two parabolic reflectors will inherently be clumsy, and thus be difficult to find a suitable installation site for, especially in urban areas, and may also be expensive.

A known alternative repeater antenna consists of a sheet of a reflective material such as metal. In such a repeater antenna, the incident angle and the angle of reflection will be equal, which will limit the usefulness of the reflector.

### DISCLOSURE OF THE INVENTION

As described above, there is a need for a repeater antenna which can be used in applications in the microwave range, and which will overcome the drawbacks of the known repeater antennas.

Such a repeater antenna is offered by the present invention in that it discloses a repeater antenna which comprises a plurality of radiation elements arranged in a first layer or plane.

The repeater antenna also comprises a ground plane spaced apart from the radiation elements by a dielectric material, and the radiation elements are each given such an extension and have such a distance between them that an incident electromagnetic wave will reflect from the repeater antenna at an angle that by a predetermined amount will be greater or smaller than the incident angle of the electromagnetic wave.

In a preferred embodiment, the repeater antenna is essentially plane, due to the shape of the conducting plane, the ground plane and the layer of dielectric material. In another preferred embodiment, the repeater antenna is, in addition to being essentially plane, also essentially flat, due to the shape of the conducting plane, the ground plane and the layer of dielectric material.

By means of the invention, a repeater antenna is obtained which can be installed in locations which could previously not be used by repeater antennas with a high degree of directivity and low losses. The antenna of the invention is also less expensive to produce than previous repeater antennas.

### BRIEF DESCRIPTION OF THE DRAWINGS

The invention will be described in more detail in the following description, with reference to the appended drawings, in which

FIG. 1 shows a system in which the repeater antenna is used, and

FIGS. 2 and 3 show an embodiment of the repeater antenna, and

FIG. 4 shows a principle behind the repeater antenna.

### EMBODIMENTS OF THE INVENTION

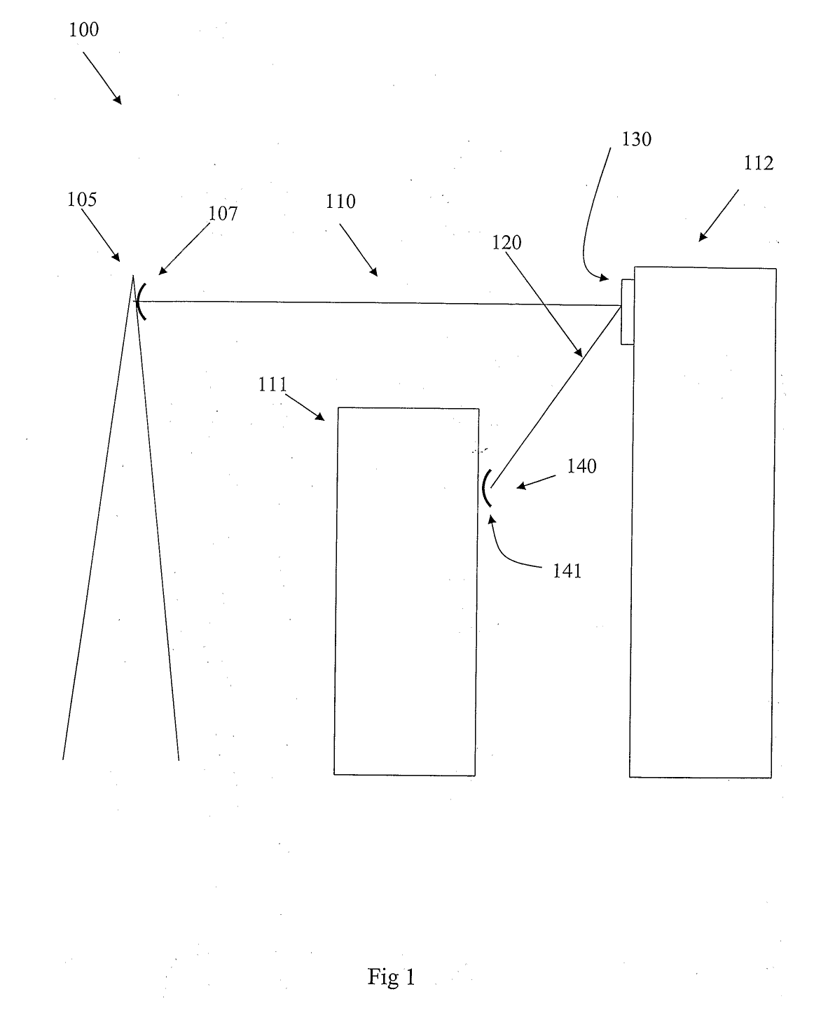

In FIG. 1, a system 100 which uses the invention is shown schematically. A radio base station (RBS) 105 is intended to cover a cell in a mobile telephony system. Within the cell, there is an area which the RBS 105 cannot cover, either due to a high concentration of users in that area, so that the capacity of the of the RBS isn't sufficient, or due to the fact that the Line Of Sight (LOS) from the RBS to the area is obscured by, for example high-rise buildings. In FIG. 1, the area is shown as being obscured from the RBS by a building 111.

Naturally, the two factors mentioned can also occur in combination, an area with a high concentration of users can be obscured by buildings or other obstacles.

As shown in FIG. 1, there is an additional RBS 140, installed on a structure 111 such as a building, in order to help the RBS 105 cover the area in question. This additional RBS 140 can be a so called “micro” or “pico” base station, i.e. a base station with reduced capacity compared to an ordinary RBS, intended to be used to enhance the capacity of an ordinary RBS. Naturally, the same effect can also be achieved using an ordinary RBS as the additional RBS 140. Thus, the additional RBS 140 is intended to enhance the capacity of the RBS 105, and the two RBS:s are to be connected via a point to point connection with microwave radio links 107-141.

As shown in FIG. 1, there is a building 112 which has LOS to the RBS 105. Due to the geometry of the system, the additional RBS 140 with its radio link 141 cannot be placed on the building 112, but needs to be placed on the building 111, where there isn't LOS to the RBS 105 or its radio link 107. However, a repeater antenna can be installed on the building 112, so that it has LOS to both of the radio links 107 and 141.

As can also be seen in FIG. 1, the geometry is such that an electrical signal transmitted over the radio link connection from the RBS 105 to the repeater antenna 130 needs to be reflected towards the additional RBS 140 at an angle which differs from the incident angle. Normally, this could only be achieved by using two separate repeater antennas, one pointed towards each RBS 105,130, with the two repeater antennas being connected to each other. Such a repeater design would normally consist of two parabolic reflectors connected to each other, which would give the repeater antenna a bulky shape, thus making it difficult to install.

In order to overcome this and other drawbacks in known repeater designs, the invention discloses a repeater antenna in which an incident electromagnetic wave will reflect from the repeater antenna at an angle that will differ from the incident angle, i.e. the angle of reflection will by a predetermined amount be greater or smaller than the incident angle of the electromagnetic wave.

In order to make the choice of installation site for the repeater antenna 130 of the invention as easy as possible, the repeater antenna is essentially plane, due to a number of factors which will be explained in more detail later in this text.

The word “plane” in this context refers to the fact that the thickness of the repeater antenna is significantly less than its width or breadth. Thus, the repeater antenna can be curved while still being plane in the sense that the word is used here, much as a sheet of paper or a sheet of metal can be curved while still being plane. This will further facilitate installation of the antenna, but in one embodiment, the repeater antenna can also be essentially flat, i.e. plane and not curved.

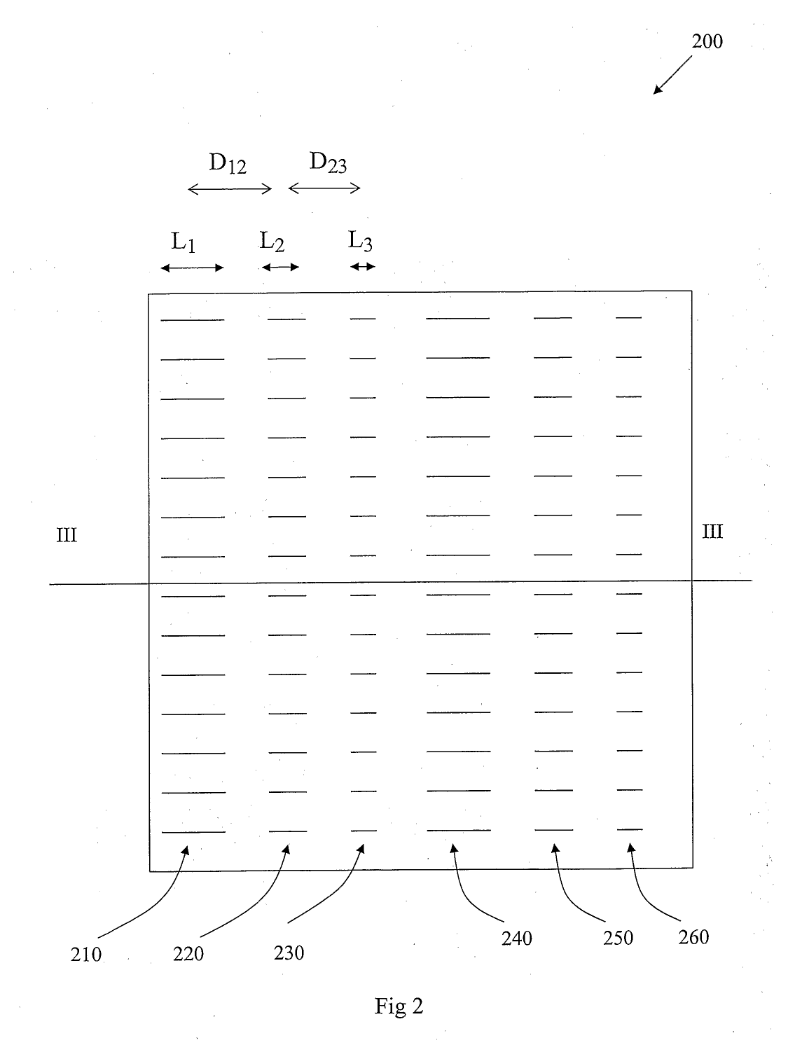

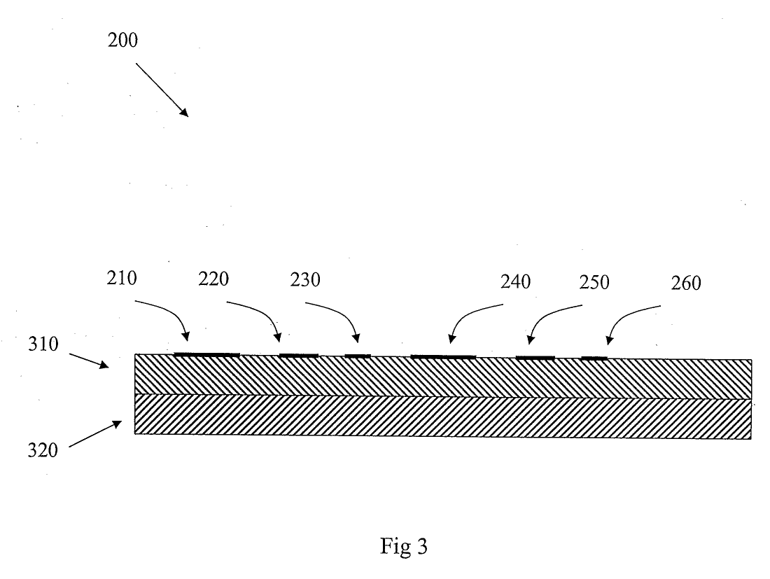

In FIG. 2, a repeater antenna 200 of the invention is shown in a front perspective. As can be seen, the repeater antenna 200 comprises a plurality of radiation elements 210-260, which are of different lengths L₁, L₂, L₃, and which are spaced apart from neighbouring radiation elements by individual distances D₁₂, D₂₃.

In the antenna 200 shown in FIG. 2, the radiation elements are arranged in a two-dimensional array of columns and rows, with elements in one row having a first extension L₁ in a first direction, and elements in a neighbouring row having a second extension L₂ in said first direction. The first direction is in this case the direction in which the columns are arranged, i.e. perpendicular to the direction of extension of the rows.

The distances mentioned between the radiation elements are in this case predetermined centre distances D₁₂, D₂₃, between radiation elements 210, 220, 230, in neighbouring rows.

As can be seen, the extension in the first direction gradually decreases in the rows from left to right in the repeater antenna, and the pattern is then repeated in a second group of rows 240, 250, 260, these rows being identical to the rows 210, 220, 230, in the first group.

The distance and difference in extensions between the elements of neighbouring rows is such that the phase of the reflected beam, and thus the reflection angle, is controlled to be given the desired difference from the incident angle. Thus, a gradual phase shift in the reflected beam is caused over the surface of the antenna, in this case from left to right, the phase shift in turn causing the reflection angle of the electromagnetic wave to differ from the incident angle of said wave.

This is also the reason that the pattern of the rows is repeated after a certain amount of rows, in this case after three rows: when the phase shift exceeds 360 degrees, or 2π when seen in radians, the pattern will start over again.

In FIG. 3, the repeater antenna 200 of FIG. 2 is shown in a cross section along the line III-III indicated in FIG. 2.

As can be seen in this cross sectional view, the repeater antenna comprises an electrically conducting ground plane 320 and a layer 310 of a dielectric material is arranged with a first surface facing the ground plane 320.

The radiation elements 210-260 are arranged on a second surface of the layer of dielectric material 310, said second surface facing away from the ground plane 320, so that the dielectric layer will have the function of spacing apart the ground plane 320 and the radiation elements 210-260.

Suitably, the radiation elements are created on the dielectric layer by means of etching of a layer of conducting material which is deposited on the second surface of the dielectric layer. Thus, a layer of electrically conducting material will be, created on the dielectric layer, said conducting layer being the layer of the radiation elements.

If it is desired, the repeater antenna as shown in FIGS. 2 and 3 can be given a curved shape by means of shaping the conducting plane, the ground plane and the layer of dielectric material. This could be done, for example, in order to either to influence the angles of incidence or reflection, or to fit the mechanical installation at a particular site better. In such an embodiment, although being curved, the repeater antenna would still retain its essentially plane form.

However, the repeater antenna can also, in addition to being essentially plane also be essentially flat, which will also be achieved due to the shape of the conducting plane, the ground plane and the layer of dielectric material.

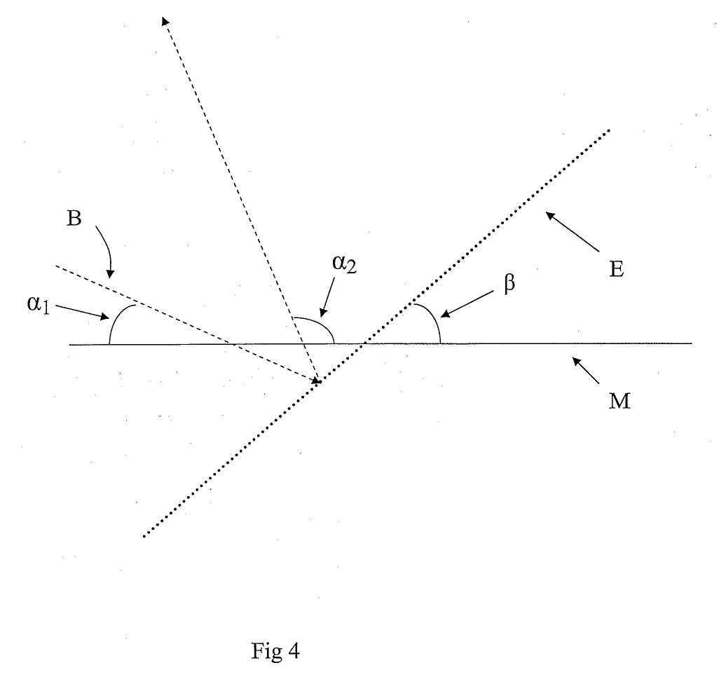

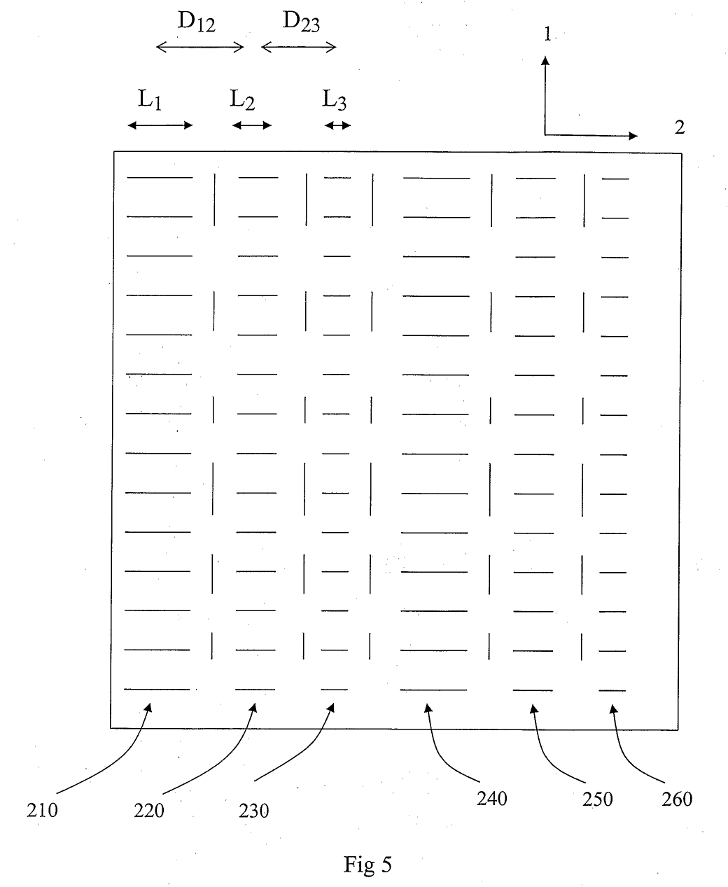

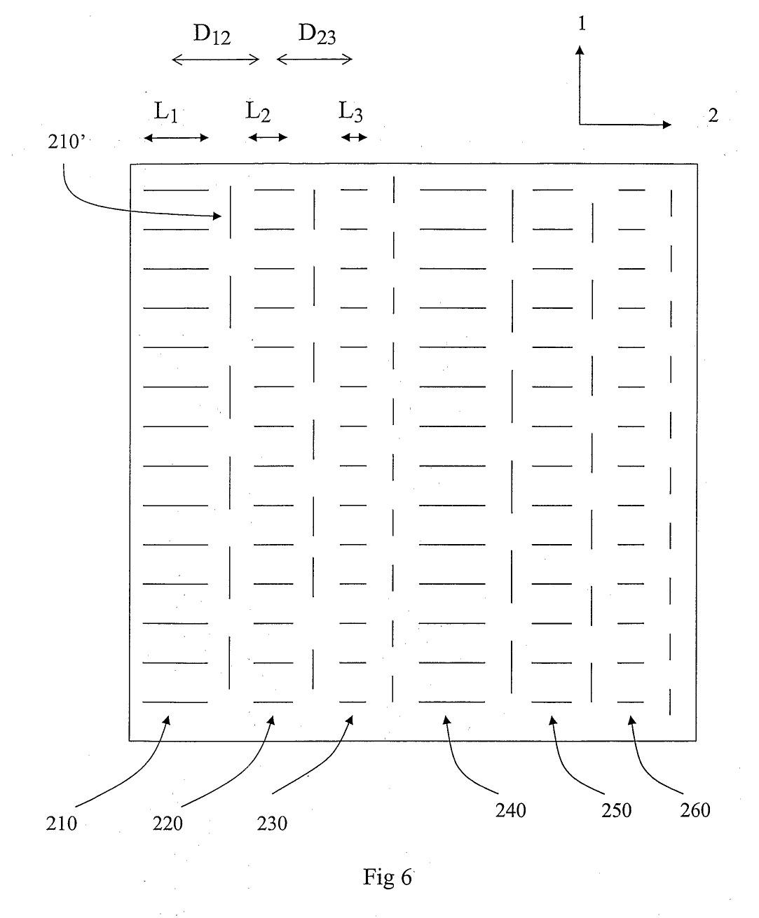

In FIG. 4, a principle behind the repeater antenna 200 of the invention is shown: the mechanical surface of the antenna 200 is indicated by means of an “M”, and an incident electromagnetic wave is indicated by means of a B”, the reflection of the beam also being shown in FIG. 4.

As can be seen, the incident angle α₁ of the electrical beam with respect to the surface of the antenna differs from the reflection angle α₂ of the beam with respect to the same surface, which is exactly the desired effect. The difference between the two angles α₁ and α₂ can be more or less tailor-made according to the needs of the application by the tailoring the extension of the radiation elements and the distances between them.

In FIG. 4, the electrical reflection plane which is created by means of the design of the antenna is also shown, indicated with the letter “E”. The electrical reflection plane is the plane which is “perceived” by the incident electromagnetic wave “B” upon reflection, and as can be seen, the incident angle and the reflection angle are the same with respect to this plane for the beam “B”.

The difference in angle between the two planes “M” and “B”, shown as β in FIG. 4, will thus be the determining factor behind the difference between the two angles α₁ and α₂.

The invention can be varied in a large number of ways. For example, if the radiation elements are arranged in rows and columns as shown in FIGS. 2 and 3, the radiation elements in one and the same row do not need to be of equal lengths, but can vary in length along the row as well. In such a case, the reflection angle can be varied in two directions, not just in the left-right direction described in conjunction with FIG. 2.

The repeater antenna can also be varied polarization-wise: rows of radiation elements which give a second polarization perpendicular to polarization of the radiation elements 210-260 can be interspersed between the rows of elements 210-260, as shown in FIG. 5, the two polarization directions being shown in a coordinate system and indicated by the numerals “1” and “2” respectively. In the embodiment shown in FIG. 5, each row of elements with similar length for the first polarization is perpendicular to the corresponding row for the second polarization. The difference between incident and reflected angle will be different in the two polarizations in this repeater antenna, so that there will be two reflected antenna beams which have different directions with respect to each other, one in each polarization, even if they are co-incident.

If it is desired to achieve the same difference between incident and reflected angle in the two polarizations, the embodiment of FIG. 6 can be used instead: here a row of elements 210′ of equal length intended for the second polarization is arranged parallel to the corresponding row of elements 210 for the first polarization, the elements for the second polarization being arranged with their edges pointing towards each other.

The radiation elements of the two different polarizations can also be arranged with a second layer of dielectric material between them, in which case they could “cross” each other.

As an alternative, if it is desired to steer the antenna beams in detail and in more than one direction, it would be conceivable to use the antenna of FIGS. 2 and 3, and to then have a mechanical installation of the antenna in which one or more trim screws would influence the mechanical tilt of the repeater antenna. In such an application, it would be possible to manufacture a set number of repeater antenna types, with known differences between reflection and incident angles. The repeater antenna which best matches the application would be installed, and the trims screws of the mechanical installation would be used to adapt the antenna to the particular installation site.

The invention is not limited to the examples of embodiments described and shown above, but may be freely varied within the scope of the appended claims. For example, although the radiation elements have been shown as elongated elements, they may be embodied in many other forms such as, for example circular, elliptical, or as rectangular patches. They may also be embodied as slits in a conducting plane, instead of as patches around which the rest of the conducting plane has been removed.

Adjacent rows of radiation elements, such as those shown in FIG. 2, may also be interwoven with each other, if neighbouring rows are displaced slightly in the main direction of the row.

Naturally, the repeater antenna of the invention may be used within a wide variety of applications, and is not in any way restricted to the use which is shown in the examples of embodiments shown and described above.

1.-4. (canceled)

5. A repeater antenna, comprising a plurality of radiation elements arranged in a first electrically conducting layer or plane, the repeater antenna having a ground plane spaced apart from the radiation elements by a layer of dielectric material, wherein the radiation elements are each given an extension (L₁, L₂, L₃) and a distance (D₁₂, D₂₃) to neighboring radiation elements that an incident electromagnetic wave reflects from the repeater antenna at an angle (α₁) that by a predetermined amount will be greater or smaller than the incident angle (α₂) of the electromagnetic wave.

6. The repeater antenna of claim 5, in which the radiation elements are arranged in a two-dimensional array of columns and rows, with elements in one row having a first extension (L₁, L₂, L₃) in a first direction, and elements in a neighboring row having a second extension (L₁, L₂ , L₃) in said first direction, there also being a predetermined center distance (D₁₂, D₂₃) between radiation elements in said neighboring rows, said distance and difference in extensions between the elements of neighboring rows being such that the phase of the reflected beam, and thus the reflection angle, is controlled to be given the desired difference from the incident angle.

7. The repeater antenna of claim 5, which is essentially plane, due to the shape of the conducting plane, the ground plane and the layer of dielectric material.

8. The repeater antenna of claim 7, in which the radiation elements are arranged in a two-dimensional array of columns and rows, with elements in one row having a first extension (L₁, L₂, L₃) in a first direction, and elements in a neighboring row having a second extension (L₁, L₂ , L₃) in said first direction, there also being a predetermined center distance (D₁₂, D₂₃) between radiation elements in said neighboring rows, said distance and difference in extensions between the elements of neighboring rows being such that the phase of the reflected beam, and thus the reflection angle, is controlled to be given the desired difference from the incident angle.

9. The repeater antenna of claim 5, which in addition to being essentially plane is also essentially flat, due to the shape of the conducting plane, the ground plane and the layer of dielectric material.

10. The repeater antenna of claim 9, in which the radiation elements are arranged in a two-dimensional array of columns and rows, with elements in one row having a first extension (L₁, L₂, L₃) in a first direction, and elements in a neighboring row having a second extension (L₁, L₂ , L₃) in said first direction, there also being a predetermined center distance (D₁₂, D₂₃) between radiation elements in said neighboring rows, said distance and difference in extensions between the elements of neighboring rows being such that the phase of the reflected beam, and thus the reflection angle, is controlled to be given the desired difference from the incident angle.
